(19) United States
(12) Patent Application Publication
(10) Pub. No.: US 2018/0358170 A1
(43) Pub. Date: Dec. 13, 2018

(54) REACTOR

(71) Applicants: AutoNetworks Technologies, Ltd., Yokkaichi (JP); Sumitomo Wiring Systems, Ltd., Yokkaichi (JP); SUMITOMO ELECTRIC INDUSTRIES, LTD., Osaka (JP)

(72) Inventors: Tatsuo Hirabayashi, Yokkaichi (JP); Seiji Shitama, Yokkaichi (JP); Kouhei Yoshikawa, Yokkaichi (JP)

(21) Appl. No.: 15/972,884

(22) Filed: May 7, 2018

(30) Foreign Application Priority Data
Jun. 8, 2017 (JP) 2017-113831

(51) Int. Cl. H01F 27/30; H01F 27/32; H01F 3/14; H01F 37/00; H01F 27/24

(52) U.S. Cl. CPC H01F 27/306; H01F 27/32; H01F 27/022; H01F 37/00; H01F 27/24; H01F 3/14

(57) ABSTRACT

Provided is a reactor having a coil including a winding portion; a magnetic core including an inner core portion and an outer core portion; an inner resin portion; an outer resin portion covering the outer core portion; an inner interposed member forming multiple resin flow paths between the winding portion and the inner core portion; an end surface interposed member has a through hole into which the inner core portion is inserted and a resin filling hole that is continuous in an axial direction of the coil with at least one flow path among the multiple resin flow paths. A gap plate is interposed between the outer core portion and the inner core portion such that a space between the flow path continuous with the resin filling hole and another flow path covered by the outer core portion among the plurality of resin flow paths is not blocked.

### CROSS-REFERENCE TO RELATED APPLICATIONS

This application claims priority of Japanese Patent Application No. JP 2017-113831 filed Jun. 8, 2017.

### TECHNICAL FIELD

The present disclosure relates to a reactor.

### BACKGROUND

A reactor is a component of a circuit that performs a voltage step-up operation and a voltage step-down operation. For example, JP 2017-28142A discloses a reactor that includes a coil including a winding portion, a magnetic core that is arranged inside and outside of the coil (winding portion) and forms a closed magnetic circuit, and an insulating interposed member that is interposed between the coil (winding portion) and the magnetic core. The above-described magnetic core includes an inner core portion that is arranged inside of the winding portion and an outer core portion that is arranged outside of the winding portion. The insulating interposed member includes an inner interposed member that is interposed between the inner circumferential surface of the winding portion and the inner core portion, and an end surface interposed member that is interposed between the end surface of the winding portion and the outer core portion. Also, the reactor disclosed in JP 2017-28142A includes an inner resin portion with which the space between the inner circumferential surface of the winding portion of the coil and the inner core portion is filled, and an outer resin portion that covers part of the outer core portion.

In the reactor disclosed in JP 2017-28142A, an interval (resin flow path) is formed between the inner circumferential surface of the winding portion and the outer circumferential surface of the inner core portion by the inner interposed member. Also, the outer circumference of the outer core portion is covered with resin, the resin is introduced through a resin filling hole formed in the end surface interposed member, and the resin fills the resin flow path formed between the winding portion and the inner core portion from the end surface side of the winding portion, whereby the outer resin portion and the inner resin portion are formed integrally. Also, at this time, resin also fills the space between the outer core portion and the inner core portion, and thus a gap is formed by the inner resin portion between the outer core portion and the inner core portion.

### SUMMARY

In the above-described reactor including the inner resin portion and the outer resin portion, it is desirable that the interval between the outer core portion and the inner core portion is maintained when the inner resin portion is formed by resin filling the space between the inner circumferential surface of the winding portion and the inner core portion.

A method of performing resin molding by arranging a combined body obtained by combining a coil, a magnetic core, and an insulating interposed member in a mold and injecting resin into the mold is an example of a method for manufacturing the above-described reactor. With this method, the outer core portion is covered with resin, the space between the winding portion and the inner core portion is filled via the resin filling hole, and the outer resin portion and the inner resin portion are integrally formed. In general, the injection of the resin into the mold is performed by applying pressure to the resin through injection molding, but it is necessary to apply a high pressure in order to cause the resin to sufficiently spread to the narrow interval between the inner circumferential surface of the winding portion and the outer circumferential surface of the inner core portion. If the pressure of the resin is increased, the outer core portion is pressed toward the inner core portion by the pressure and the interval between the outer core portion and the inner core portion becomes narrow in some cases, and thus there is a risk that a predetermined inductance will not be obtained.

In view of this, for example, it is conceivable to provide a protrusion (pin) that fixes the outer core portion in the mold and bring the outer core portion into contact with the protrusion, so that the outer core portion does not move in the mold. However, in this case, the surface of the outer core portion that comes into contact with the protrusion is not covered with the resin and is exposed from the outer resin portion, and therefore there is concern that rusting will occur at the part of the outer core portion that is exposed from the outer resin portion.

An aim of the present disclosure is to provide a reactor that can maintain an interval between the outer core portion and the inner core portion when the inner resin portion is formed by resin filling the space between the inner circumferential surface of the winding portion of the coil and the inner core portion of the magnetic core.

A reactor according to the present disclosure includes a coil having a winding portion; a magnetic core including an inner core portion arranged inside of the winding portion and an outer core portion arranged outside of the winding portion; an inner resin portion with which a space between an inner circumferential surface of the winding portion and the inner core portion is filled; an outer resin portion that covers at least part of the outer core portion; an inner interposed member that is interposed between the inner circumferential surface of the winding portion and the inner core portion and forms a plurality of resin flow paths that are to serve as flow paths for resin that forms the inner resin portion; an end surface interposed member that is interposed between an end surface of the winding portion and the outer core portion and includes a through hole into which the inner core portion is inserted and a resin filling hole that is continuous in an axial direction of the coil with at least one flow path among the plurality of resin flow paths; and a gap plate that is attached in the through hole of the end surface interposed member and is interposed between the outer core portion and the inner core portion. Wherein the gap plate is formed such that, when a combined body obtained by combining the coil, the magnetic core, the inner interposed member, and the end surface interposed member is viewed in the axial direction of the coil, and a space between the flow path continuous with the resin filling hole and another flow path covered by the outer core portion among the plurality of resin flow paths is not blocked.

The above-described reactor can maintain an interval between the outer core portion and the inner core portion when the inner resin portion is formed by filling the space between the inner circumferential surface of the winding portion of the coil and the inner core portion of the magnetic core with resin.

### BRIEF DESCRIPTION OF THE DRAWINGS

FIG. 1 is a schematic perspective view of a reactor according to Embodiment 1.

FIG. 2 is a schematic top view of the reactor according to Embodiment 1.

FIG. 3 is a schematic perspective view of a combined body included in the reactor according to Embodiment 1.

FIG. 4 is a schematic horizontal cross-sectional view obtained by cutting along line (IV)-(IV) shown in FIG. 1.

FIG. 5 is a schematic plane cross-sectional view obtained by cutting along line (V)-(V) shown in FIG. 1.

FIG. 6 is a schematic front view showing a view from a front surface side of an end surface interposed member included in the reactor according to Embodiment 1.

FIG. 7 is a schematic rear view showing a view from a rear surface side of the end surface interposed member included in the reactor according to Embodiment 1.

FIG. 8 is a schematic front view of a combined body included in the reactor according to Embodiment 1.

### DETAILED DESCRIPTION OF PREFERRED EMBODIMENTS

First, embodiments of the present invention will be listed and described.

The reactor according to one aspect includes: a coil including a winding portion; a magnetic core including an inner core portion arranged inside of the winding portion and an outer core portion arranged outside of the winding portion; an inner resin portion with which a space between an inner circumferential surface of the winding portion and the inner core portion is filled; an outer resin portion that covers at least part of the outer core portion; an inner interposed member that is interposed between the inner circumferential surface of the winding portion and the inner core portion and forms a plurality of resin flow paths that are to serve as flow paths for resin that forms the inner resin portion; an end surface interposed member that is interposed between an end surface of the winding portion and the outer core portion and includes a through hole into which the inner core portion is inserted and a resin filling hole that is continuous in an axial direction of the coil with at least one flow path among the plurality of resin flow paths; and a gap plate that is attached in the through hole of the end surface interposed member and is interposed between the outer core portion and the inner core portion.

Wherein the gap plate is formed such that, when a combined body obtained by combining the coil, the magnetic core, the inner interposed member, and the end surface interposed member is viewed in the axial direction of the coil, and a space between the flow path continuous with the resin filling hole and another flow path covered by the outer core portion among the plurality of resin flow paths is not blocked.

According to the above-described reactor, by including the gap plate, the interval between the outer core portion and the inner core portion can be suitably maintained by the gap plate when the inner resin portion is formed, and therefore a predetermined inductance can be ensured.

Also, with the above-described reactor, multiple resin flow paths formed between the inner circumferential surface of the winding portion and the inner core portion by the inner interposed member are filled with resin, whereby the inner resin portion is formed. Among the multiple resin flow paths, the flow path that is continuous in the axial direction of the coil with the resin filling hole formed in the end surface interposed member can be directly filled with resin through the resin filling hole. On the other hand, the other flow path covered by the outer core portion cannot be directly filled with resin through the resin filling hole, and therefore is filled through the space between the outer core portion and the inner core portion with the resin introduced through the resin filling hole. The above-described reactor is formed such that the gap plate arranged between the outer core portion and the inner core portion does not block the space between the flow path that is continuous with the resin filling hole and the other flow path that is covered by the outer core portion. For this reason, the flow paths for the resin can be ensured between the outer core portion and the inner core portion, where the gap plate is arranged, and the resin introduced through the resin filling hole can indirectly fill the other flow paths. Accordingly, with the above-described reactor, the resin can fill the resin flow paths, and the inner resin portion can be formed.

As one aspect of the above-described reactor, an engagement structure for engaging the end surface interposed member and the gap plate is included.

According to the above-described aspect, the end surface interposed member and the gap plate are engaged to each other using the engagement structure, whereby the gap plate can be attached to and supported by the end surface interposed member, and the gap plate is easy to arrange at a predetermined position when the reactor is assembled.

As an aspect of the above-described reactor, the gap plate includes a positioning portion that positions the outer core portion.

According to the above-described aspect, the gap plate includes a positioning portion, whereby the outer core portion is easy to position with respect to the end surface interposed member.

A specific example of a reactor according to an embodiment of the present invention will be described hereinafter with reference to the drawings. Items with the same name are denoted by the same reference numerals in the drawings. Note that the present invention is not limited to these examples and is indicated by the claims, and meanings equivalent to the claims and all changes within the scope are intended to be encompassed therein.

### Embodiment 1

Configuration of Reactor

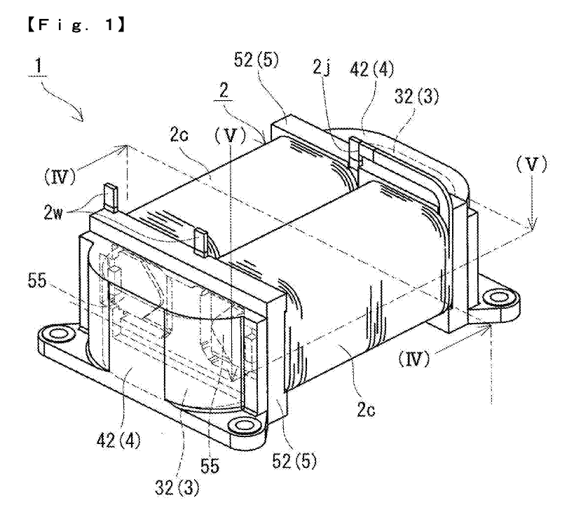

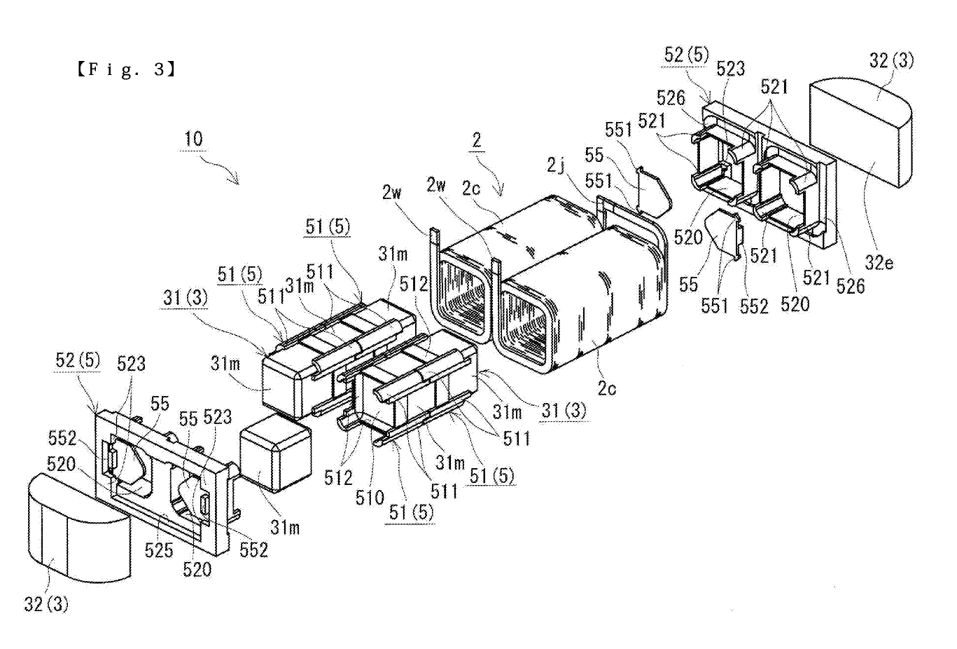

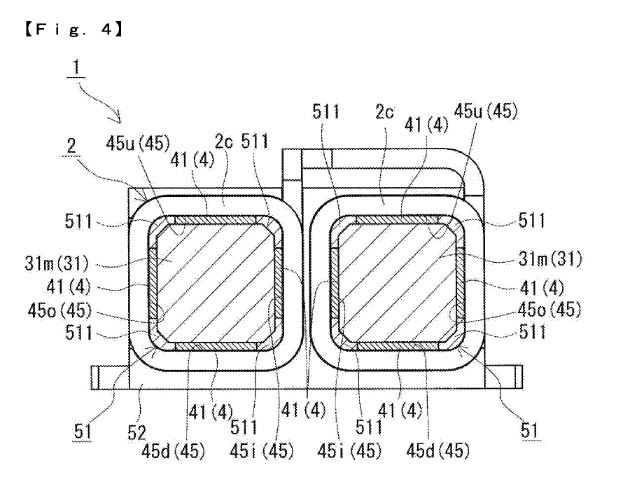

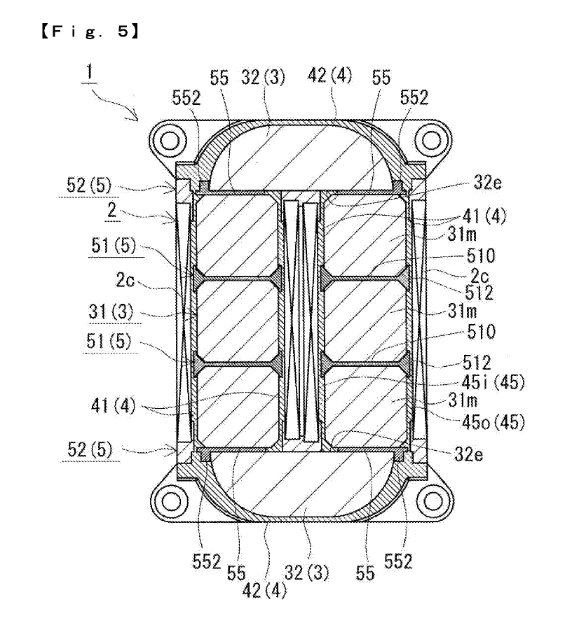

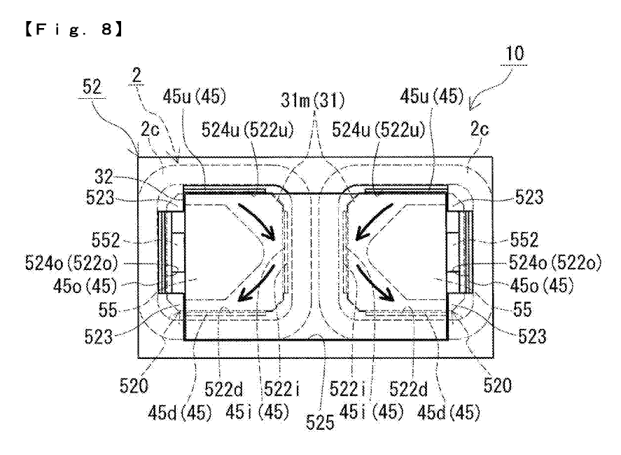

A reactor 1 according to Embodiment 1 will be described with reference to FIGS. 1 to 8. As shown in FIGS. 1 to 3, the reactor 1 of Embodiment 1 includes a combined body 10 (see FIG. 3) that includes a coil 2 having winding portions 2c, a magnetic core 3 arranged inside and outside of the winding portions 2c, and insulating interposed members 5 interposed between the coil 2 and the magnetic core 3. The coil 2 includes two winding portions 2c, and the two winding portions 2c are arranged in horizontal alignment with each other. The magnetic core 3 includes two inner core portions 31 that are arranged inside of the winding portions 2c and two outer core portions 32 that are arranged outside of the winding portions 2c and connect the end portions of the two inner core portions 31. The insulating interposed members 5 include inner interposed members 51 that are interposed between the inner circumferential surfaces of the winding portions 2c and the inner core portions 31, and end surface interposed members 52 that are interposed between the end surfaces of the winding portions 2c and the outer core portions 32. Also, as shown in FIGS. 4 and 5, the reactor 1 includes a molded resin portion 4 that integrally covers the magnetic core 3 (inner core portions 31 and outer core portions 32). The molded resin portion 4 includes inner resin portions 41 that fill the spaces between the inner circumferential surfaces of the winding portions 2c and the inner core portions 31, and outer resin portions 42 that cover at least part of the outer core portions 32. As shown in FIGS. 3 and 5, one feature of the reactor 1 lies in that it includes gap plates 55 interposed between the outer core portions 32 and the inner core portions 31, and the gap plates 55 are formed such that flow paths for resin (see FIG. 8) can be ensured between the outer core portions 32 and the inner core portions 31.

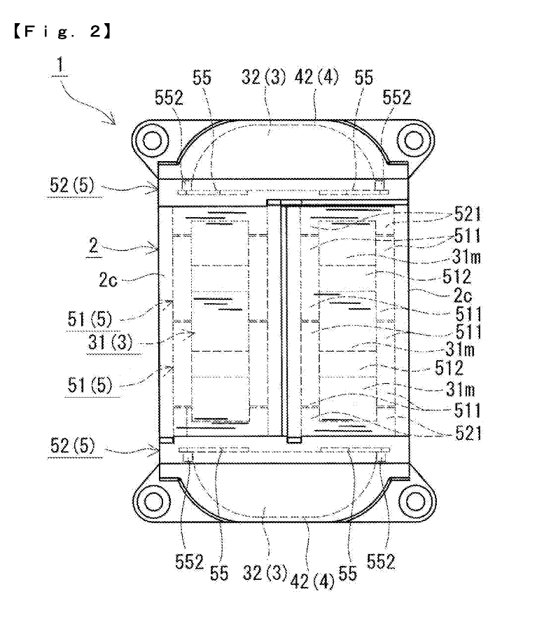

The reactor 1 is installed in an installation target (not shown) such as a converter case, for example. Here, in the reactor 1 (coil 2 and magnetic core 3), the lower portions of FIGS. 1, 4, and 6 denote the installation side that faces the installation target, the installation side is set as “down”, the side opposite thereto is set as “up”, and the vertical direction is set as the height direction. Also, the alignment direction (the left-right direction of FIGS. 2 and 5) of the winding portions 2c of the coil 2 is set as the horizontal direction, and the direction along the axial direction (vertical direction in FIGS. 2 and 5) of the coil 2 (winding portions 2c) is set as the length direction. FIG. 4 is a horizontal cross-sectional view obtained by cutting in the horizontal direction orthogonal to the axial direction of the winding portions 2c, and FIG. 5 is a plane cross-sectional view obtained by cutting with a plane that divides the winding portions 2c into top and bottom. Hereinafter, configurations of the reactor will be described in detail.

Coil

As shown in FIGS. 1 to 3, the coil 2 includes two winding portions 2c that are formed by respectively winding two winding wires 2w in the form of spirals, and end portions on one side of the winding wires 2w that form the two winding portions 2c are connected to each other via a bonding portion 2j. The two winding portions 2c are arranged in horizontal alignment (in parallel) such that the axial directions thereof are parallel. The bonding portion 2j is formed by bonding the end portions on the one side of the winding wires 2w pulled out from the winding portions 2c, using a bonding method such as welding, soldering, or brazing. The end portions on the other side of the winding wires 2w are pulled out in an appropriate direction (in this example, upward) from the winding portions 2c. Terminal fittings (not shown) are attached as appropriate to the other end portions of the winding wires 2w (i.e., the two ends of the coil 2) and are electrically connected to an external apparatus (not shown) such as a power source. A known coil can be used as the coil 2, and for example, the two winding portions 2c may be formed with one continuous winding wire.

Winding Portions

The two winding portions 2c are composed of winding wires 2w with the same specification and have the same shape, size, winding direction, and turn count, and the adjacent turns that form the winding portions 2c are adhered to each other. For example, the winding wires 2w are coated wires (so-called enamel wires) that have conductors (copper, etc.) and insulating coverings (polyamide-imide, etc.) on the outer circumferences of the conductors. In this example, the winding portions 2c are quadrangular cylinder-shaped (specifically, rectangular cylinder-shaped) edgewise coils obtained by winding the winding wires 2w, which are coated flat wires, in an edgewise manner, and the end surface shapes of the winding portions 2c viewed from the axial direction are rectangular shapes with rounded corner portions (see FIG. 4 as well). The shapes of the winding portions 2c are not particularly limited, and for example, may be cylinder-shaped, elliptical cylinder-shaped, ovoid cylinder-shaped (racetrack-shaped), or the like. The specifications of the winding wires 2w and the winding portions 2c can be changed as appropriate.

In this example, when the reactor 1 is formed without the coil 2 (winding portions 2c) being covered with the molded resin portion 4, as shown in FIG. 1, the outer circumferential surface of the coil 2 is in an exposed state. For this reason, it is easy to dissipate heat to the exterior from the coil 2, and the heat dissipation property of the coil 2 can be increased.

In addition, the coil 2 may be a molded coil molded using resin having an electrical insulating property. In this case, the coil 2 can be protected from the external environment (dust, corrosion, and the like) and the mechanical strength and electrical insulating property of the coil 2 can be increased. For example, due to the inner circumferential surfaces of the winding portions 2c being covered with resin, electrical insulation between the winding portions 2c and the inner core portions 31 can be increased. As the resin for molding the coil 2, for example, it is possible to use a thermosetting resin such as epoxy resin, unsaturated polyester resin, urethane resin, or silicone resin, or a thermoplastic resin such as polyphenylene sulfide (PPS) resin, polytetrafluoroethylene (PTFE) resin, liquid crystal polymer (LCP), polyamide (PA) resin such as nylon 6 and nylon 66, polyimide (PI) resin, polybutylene terephthalate (PBT) resin, and acrylonitrile butadiene styrene (ABS) resin.

Alternatively, the coil 2 may be a heat seal coil that includes heat seal layers between adjacent turns that form the winding portions 2c, and that is formed by heat sealing adjacent turns together. In this case, the adjacent turns can be further adhered together.

Magnetic Core 3

As shown in FIGS. 2, 3, and 5, the magnetic core 3 includes two inner core portions 31 arranged inside of the winding portions 2c and two outer core portions 32 arranged outside of the winding portions 2c. The inner core portions 31 are portions that are located inside of the winding portions 2c arranged in horizontal alignment, and at which the coil 2 is arranged. In other words, the two inner core portions 31 are arranged in horizontal alignment (in parallel), similarly to the winding portions 2c. Parts of the end portions in the axial direction of the inner core portions 31 may protrude from the winding portions 2c. The outer core portions 32 are portions that are located outside of the winding portions 2c, and on which the coil 2 is substantially not arranged (i.e., portions that protrude (are exposed) from the winding portions 2c). The outer core portions 32 are provided so as to connect the end portions of the two inner core portions 31. In this example, the outer core portions 32 are respectively arranged so as to sandwich the inner core portions 31 from the two ends, and the end surfaces of the two inner core portions 31 oppose and are connected to respective inner end surfaces 32e of the outer core portions 32, whereby a ring-shaped magnetic core 3 is constituted. In the present embodiment, as shown in FIGS. 3 and 5, the gap plates 55 are arranged between the outer core portions 32 and the inner core portions 31. When induction occurs due to a current being applied to the coil 2, a magnetic flux flows in the magnetic core 3, whereby a closed magnetic circuit is formed.

Inner Core Portions

The shapes of the inner core portions 31 are shapes that correspond to the inner circumferential surfaces of the winding portions 2c. In this example, the inner core portions 31 are formed in quadrangular prism shapes (rectangular prism shapes), and the end surface shapes of the inner core portions 31 viewed from the axial direction are rectangular shapes with chamfered corner portions (see FIG. 4 as well). As shown in FIG. 4, the outer circumferential surfaces of the inner core portions 31 each have four flat surfaces (an upper surface, a lower surface, and two side surfaces) and four corner portions. Here, the sides of the two winding portions 2c that face each other are denoted as inner sides, and the opposite sides are denoted as outer sides, and among the two side surfaces, the side surfaces on the inner sides of the two winding portions 2c that oppose each other are denoted as inner side surfaces, and the side surfaces on the outer sides, which are located on the sides opposite to the inner sides, are denoted as outer side surfaces. Also, in this example, as shown in FIGS. 2, 3, and 5, the inner core portions 31 each include multiple inner core pieces 31m and the inner core pieces 31m are configured to be coupled in the length direction.

The inner core portions 31 (inner core pieces 31m) are formed with a material that contains a soft magnetic material. For example, the inner core pieces 31m are formed with pressed powder molded bodies obtained by press-molding a soft magnetic powder such as iron or an iron alloy (Fe—Si alloy, Fe—Si—Al alloy, Fe—Ni alloy, or the like), a coating soft magnetic powder further including an insulating coating, and the like, molded bodies made of a composite material containing a soft magnetic powder and a resin, or the like. As the resin for the composite material, it is possible to use a thermosetting resin, a thermoplastic resin, a normal-temperature curable resin, a low-temperature curable resin, or the like. Examples of thermosetting resins include unsaturated polyester resin, epoxy resin, urethane resin, and silicone resin. Examples of thermoplastic resins include PPS resin, PTFE resin, LCP, PA resin, PI resin, PBT resin, and ABS resin. In addition, it is also possible to use a BMC (bulk molding compound) obtained by mixing calcium carbonate and glass fiber into unsaturated polyester, millable silicone rubber, millable urethane rubber, or the like. In this example, the inner core pieces 31m are formed with pressed powder molded bodies.

Outer Core Portions

As shown in FIGS. 2, 3, and 5, the outer core portions 32 are each constituted by one core piece. Similarly to the inner core pieces 31m, the outer core portions 32 are formed with a material containing a soft magnetic material, and it is possible to use the above-described pressed powder molded bodies, composite materials, or the like thereas. In this example, the outer core portions 32 are formed with pressed powder molded bodies.

The shapes of the outer core portions 32 are not particularly limited. In this example, when the magnetic core 3 is formed, the outer core portions 32 protrude downward with respect to the inner core portions 31 and the lower surfaces of the outer core portions 32 are level with the lower surface of the coil 2 (winding portions 2c) (see FIG. 8). The upper surfaces of the outer core portions 32 are level with the upper surfaces of the inner core portions 31.

Insulating Interposed Members

As shown in FIGS. 2 and 3, the insulating interposed members 5 are members that are interposed between the coil 2 (winding portions 2c) and the magnetic core 3 (inner core portions 31 and outer core portions 32) and that ensure electrical insulation between the coil 2 and the magnetic core 3, and include the inner interposed members 51 and the end surface interposed members 52. The insulating interposed members 5 (inner interposed members 51 and end surface interposed members 52) are formed with resin having an electrical insulating property, such as epoxy resin, unsaturated polyester resin, urethane resin, silicone resin, PPS resin, PTFE resin, LCP, PA resin, PI resin, PBT resin, or ABS resin. In this example, the inner interposed members 51 and the end surface interposed members 52 are formed with PPS resin.

Inner Interposed Members

As shown in FIGS. 3 and 4, the inner interposed members 51 are interposed between the inner circumferential surfaces of the winding portions 2c and the outer circumferential surfaces of the inner core portions 31, and ensure electrical insulation between the winding portions 2c and the inner core portions 31. Also, as shown in FIG. 4, between the inner circumferential surfaces of the winding portions 2c and the outer circumferential surfaces of the inner core portions 31, the inner interposed members 51 form multiple (in this example, four) resin flow paths 45 that are to serve as flow paths for resin that is to form the inner resin portions 41. In this example, the inner interposed members 51 include rectangular plate portions 510 (see FIGS. 3 and 5) that are interposed between the inner core pieces 31m, and protruding pieces 511 (see FIGS. 2 and 4) that are formed on the corner portions of the plate portions 510 and extend in the length direction along the corner portions of the adjacent inner core pieces 31m. Furthermore, in this example, frame portions 512 (see FIGS. 3 and 5) that surround the circumferential edge portions of the end surfaces of adjacent inner core pieces 31m are formed on the outer edge portions of the plate portions 510. The plate portions 510 hold the intervals between the inner core pieces 31m and form gaps between the inner core pieces 31m. The protruding pieces 511 hold the corner portions of the inner core pieces 31m, are interposed between the inner circumferential surfaces of the winding portions 2c and the outer circumferential surfaces of the inner core pieces 31m, and position the inner core pieces 31m (inner core portions 31) in the winding portions 2c. As shown in FIG. 4, intervals are formed by the protruding pieces 511 between the inner circumferential surfaces of the winding portions 2c and the outer circumferential surfaces of the inner core portions 31, and resin flow paths 45 are formed at the four surfaces (upper surface, lower surface, and two side surfaces) of each inner core portion 31. Here, among the four resin flow paths 45, the flow path located on the upper surface side of the inner core portion 31 is denoted as a resin flow path 45u, the flow path located on the outer side surface side is denoted as a resin flow path 45o, the flow path located on the lower surface side is denoted as a resin flow path 45d, and the flow path located on the inner side surface side is denoted as a resin flow path 45i. The resin flow paths 45 are flow paths for the resin that forms the inner resin portions 41, and the inner resin portions 41 are formed by resin filling the resin flow paths 45. Also, as shown in FIGS. 2 and 3, the protruding pieces 511 of the adjacent inner interposed members 51 are coupled by butting against each other.

End Surface Interposed Members

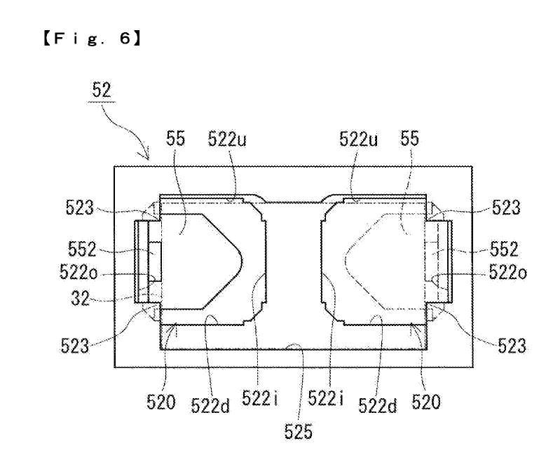

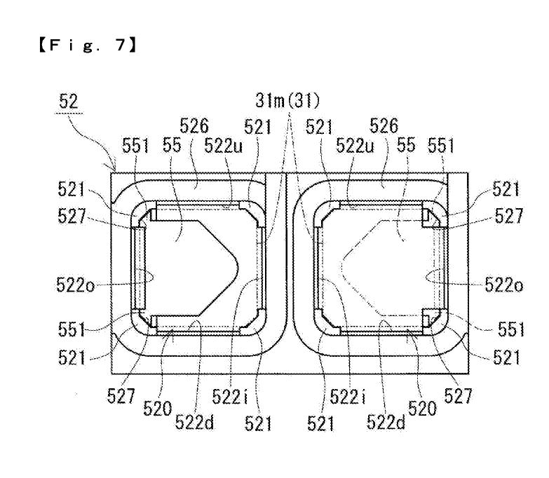

As shown in FIGS. 3 and 5, the end surface interposed members 52 are interposed between the end surfaces of the winding portions 2c and the inner end surfaces 32e of the outer core portions 32, and ensure electrical insulation between the winding portions 2c and the inner core portions 32. The end surface interposed members 52 are arranged at both ends of the winding portions 2c, and as shown in FIGS. 3, 6, and 7, are rectangular frame-shaped bodies provided with two through holes 520 through which the inner core portions 31 are inserted. In this example, as shown in FIGS. 6 and 8, protruding portions 523 that bulge inward from the corner portions of the through holes 520 are formed at positions that come into contact with the corner portions on the outer side surface sides at the end surfaces of the inner core portions 31 (inner core pieces 31m). Also, recessed portions 522u, 522o, 522d, and 522i that are outwardly recessed are formed on the upper surface sides, outer side surface sides, lower surface sides, and inner side surface sides of the inner circumferential surfaces of the through holes 520, and as shown in FIG. 7, intervals are formed between the inner circumferential surfaces of the through holes 520 and the outer circumferential surfaces of the inner core portions 31. The recessed portions 522u, 522o, 522d, and 522i are provided at positions corresponding to the end portions of the above-described resin flow paths 45u, 45o, 45d, and 45i (see FIG. 4).

Also, in the state of the combined body 10, in a view in the axial direction of the coil 2 (winding portions 2c) from the outer core portion 32 side, as shown in FIG. 8, the recessed portions 522u and 522o on the upper surface sides and outer side surface sides of the through holes 520 are exposed without being covered by the outer core portion 32, whereby the two resin filling holes 524u and 524o are formed. The resin filling holes 524u and 524o are formed at positions that are continuous with the resin flow paths 45u and 45o in the axial direction of the coil 2 (winding portions 2c), and the resin flow paths 45u and 45o are open toward the outer core portions 32 through the resin filling holes 524u and 524o. In FIG. 8, the resin flow paths 45u and 45o are open on the far side of the illustration of the resin filling holes 524u and 524o. Accordingly, via the resin filling holes 524u and 524o, it is possible to fill the spaces between the winding portions 2c and the inner core portions 31 with the resin that forms the inner resin portions 41 (see FIGS. 4 and 5). On the other hand, as shown in FIG. 8, since the recessed portions 522d and 522i on the lower surface sides and inner side surface sides of the through holes 520 are closed by being covered with the outer core portions 32, the resin flow paths 45d and 45i are covered by the outer core portions 32 and are not open toward the outer core portions 32.

As shown in FIGS. 3 and 6, recessed fitting portions 525 into which the inner end surface 32e sides of the outer core portions 32 are fit are formed on the outer core portion 32 sides (front surface sides) of the end surface interposed members 52, and the outer core portions 32 are positioned with respect to the end surface interposed members 52 by the fitting portions 525. As shown in FIGS. 3 and 7, protruding pieces 521 that extend in the length direction along the corner portions of the inner core pieces 31m located at the end portions of the inner core portions 31 are formed on the inner core portion 31 sides (rear surface sides) of the end surface interposed members 52. The protruding pieces 521 hold the corner portions of the inner core pieces 31m located on the end portions of the inner core portions 31, are interposed between the inner circumferential surfaces of the winding portions 2c and the outer circumferential surfaces of the inner core pieces 31m, and position the inner core pieces 31m (inner core portions 31) in the winding portions 2c. The inner core portions 31 are positioned with respect to the end surface interposed members 52 by the protruding pieces 521, and as a result, it is possible to position the inner core portions 31 and the outer core portions 32 via the end surface interposed members 52. Also, as shown in FIG. 2, the protruding pieces 521 of the end surface interposed members 52 are coupled by butting against the protruding pieces 511 of the inner interposed members 51. Accordingly, over the entire length in the length direction of the inner core portions 31, as shown in FIG. 4, the resin flow paths 45 are divided in the circumferential direction by the protruding pieces 511 and the protruding pieces 521.

Furthermore, in this example, as shown in FIGS. 3 and 7, groove-shaped storage portions 526 in which the end portions of the winding portions 2c are stored are formed on the inner core portion 31 sides (rear surface sides) of the end surface interposed members 52. The storage portions 526 each include a bottom surface with an inclined surface such that the entire end surface of the winding portion 2c comes into surface contact therewith.

Gap Plates

As shown in FIGS. 3 and 5, the gap plates 55 are interposed between the outer core portions 32 and the inner core portions 31 and hold the intervals between the outer core portions 32 and the inner core portions 31. As shown in FIGS. 3, 6, and 7, the gap plates 55 are attached to the left and right through holes 520 of the end surface interposed members 52. The gap plates 55 and the end surface interposed members 52 are separate members. In this example, the gap plates 55 are attached on the outer side surface sides of the through holes 520, and the shapes of the gap plates 55 are pentagonal shapes (homebase shapes). Also, as shown in FIG. 8, the gap plates 55 are formed so as to not close the end portions of the resin flow paths 45, and are formed such that the flow paths for the resin can be ensured between the outer core portions 32 and the inner core portions 31, where the gap plates 55 are arranged. The end portions of the resin flow paths 45 are open in the spaces between the outer core portions 32 and the inner core portions 31.

In this example, engagement structures for engaging the end surface interposed members 52 and the gap plates 55 are included. Specifically, as shown in FIG. 7, engagement recessed portions 527 are provided at the protruding portions 523 (see FIG. 6) formed at the corner portions on the outer side surface sides of the through holes 520, engagement protruding portions 551 that are fit into the engagement recessed portions 527 are provided on both end portions of the gap plates 55, and the engagement structures are constituted by the engagement recessed portions 527 and the engagement protruding portions 551. By fitting the engagement protruding portions 551 into the engagement recessed portions 527, the end surface interposed members 52 and the gap plates 55 engage with each other, and the gap plates 55 are attached to and supported by the end surface interposed members 52. For this reason, the gap plates 55 are easy to arrange at predetermined positions and work can be performed in a state in which the gap plates 55 are attached to the end surface interposed members 52, and therefore the task of assembling the combined body 10 is easy to perform.

In the case of using the gap plates 55 shown in FIG. 8, the gap plates 55 are formed so as not to block the spaces between the resin flow paths 45u that are continuous with the resin filling holes 524u and the other resin flow paths 45d and 45i that are covered by the outer core portions 32. Specifically, the gap plates 55 are formed such that spaces in which the gap plates 55 are not interposed between the outer core portions 32 and the inner core portions 31 are formed, and such that the spaces serve as flow paths for resin that communicate with the spaces between the resin flow paths 45u and the resin flow paths 45d and 45i. For this reason, the resin introduced through the resin filling holes 524u can fill the resin flow paths 45d and 45i through the spaces between the outer core portions 32 and the inner core portions 31 (in FIG. 8, the thick-lined arrows indicate the flow paths for the resin). The spaces in which the gap plates 55 are not interposed are also filled with resin.

The flow of resin in the resin flow paths 45 when the resin fills from the resin filling holes 524u and 524o to the inside of the winding portions 2c in this case will be described. The resin flow paths 45u and 45o that are continuous with the resin filling holes 524u and 524o are directly filled with resin through the resin filling holes 524u and 524o. On the other hand, the resin introduced through the resin filling holes 524u enters the spaces between the outer core portions 32 and the inner core portions 31 and indirectly fills the other resin flow paths 45d and 45i covered by the outer core portions 32 by passing through these spaces. In this example, the gap plates 55 are attached on the outer side surface sides of the through holes 520, and the engagement protruding portions 551 provided on both end portions of the gap plates 55 engage with the engagement recessed portions 527, whereby the spaces between the resin flow paths 45o and the resin flow paths 45d and 45i are blocked. For this reason, the resin introduced through the resin filling holes 524o does not flow into the other resin flow paths 45d and 45i and fills only the resin flow paths 45o.

Furthermore, in this example, as shown in FIGS. 3, 5, and 6, the gap plates 55 include positioning portions 552 that position the outer core portions 32. The positioning portions 552 are formed so as to protrude from the gap plates 55 toward the outer core portions 32 and to come into contact with the outer sides of the outer core portions 32. Accordingly, the outer core portions 32 can be easily positioned with respect to the end surface interposed members 52 to which the gap plates 55 are attached. In this example, the positioning portions 552 are provided on the left and right gap plates 55 and both the left and right sides of the outer core portions 32 are positioned by coming into contact with the positioning portions 552.

The size (area) of the gap plate 55 is not particularly limited, as long as it is possible to ensure a flow path for resin between the outer core portion 32 and the inner core portion 31. The area of the gap plate 55 is smaller than the area of the inner core portion 31, and for example, is 30% or more and 90% or less of the area of the end surface of the inner core portion 31. Due to the area of the gap plate 55 being 30% or more of the area of the end surface of the inner core portion 31, the interval between the outer core portion 32 and the inner core portion 31 is easy to keep constant over the entirety. Also, if the area of the gap plate 55 is 30% or more of the area of the end surface of the inner core portion 31, it is easy to suppress deformation of the gap plate 55 caused by being pressed between the outer core portion 32 and the inner core portion 31 due to the pressure during resin molding, and it is easy to maintain the interval between the outer core portion 32 and the inner core portion 31. On the other hand, due to the area of the gap plate 55 being 90% or less of the area of the end surface of the inner core portion 31, the flow path for the resin can be sufficiently ensured between the outer core portion 32 and the inner core portion 31. A more preferable area of the gap plate 55 is 50% or more and 85% or less of the area of the end surface of the inner core portion 31. It is sufficient that the thickness of the gap plate 55 is determined as appropriate such that a predetermined inductance is obtained, and for example, is 1 mm or more and 3 mm or less.

The shape of the gap plate 55 is not particularly limited, as long as it is possible to ensure a flow path for resin between the outer core portion 32 and the inner core portion 31, and for example, it is possible to select an appropriate shape such as a triangular shape or a quadrangular shape such as a rectangular shape or a trapezoidal shape.

The gap plate 55 has an electrical insulation property, is formed with a material having a smaller relative permeability than the core pieces constituting the magnetic core 3, and for example, is constituted by resin, a ceramic such as alumina, or the like. Examples of the resin include resins such as epoxy resin, unsaturated polyester resin, urethane resin, silicone resin, PPS resin, PTFE resin, LCP, PA resin, PI resin, PBT resin, and ABS resin, and fiber-reinforced resins (FRP) obtained by combining these resins with fibers. The resin gap plate 55 is easy to manufacture and has a low manufacturing cost. Also, if the gap plate 55 is formed with the same resin as the end surface interposed member 52, the thermal expansion coefficients of the gap plate 55 and the end surface interposed member 52 can be made the same, and therefore damage caused by temperature change can be suppressed. The ceramic gap plate 55 has higher strength and is less likely to deform in comparison to resin. In this example, the gap plate 55 is formed with PPS resin.

Molded Resin Portion

Also, as shown in FIGS. 4 and 5, the molded resin portion 4 integrally covers the magnetic core 3 (inner core portions 31 and outer core portions 32) and includes the inner resin portions 41 and the outer resin portions 42. The molded resin portion 4 is formed with a resin having an electrical insulation property, such as epoxy resin, unsaturated polyester resin, urethane resin, silicone resin, PPS resin, PTFE resin, LCP, PA resin, PI resin, PBT resin, and ABS resin. In this example, the inner resin portions 41 and the outer resin portions 42 are formed with PPS resin.

Inner Resin Portions

As shown in FIG. 4, the inner resin portions 41 are formed due to the resin filling the resin flow paths 45 formed between the inner circumferential surfaces of the winding portions 2c and the outer circumferential surfaces of the inner core portions 31, and the inner resin portions 41 are adhered to the inner circumferential surfaces of the winding portions 2c and the outer circumferential surfaces of the inner core portions 31.

Outer Resin Portions

As shown in FIGS. 1, 2, and 5, the outer resin portions 42 are formed so as to cover at least part of the outer core portions 32. In this example, when the combined body 10 is formed, the outer resin portions 42 are formed so as to cover the entireties of the outer core portions 32 that are exposed to the outside. Specifically, the outer circumferential surfaces, upper surfaces, and lower surfaces of the outer core portions 32, excluding the inner end surfaces 32e of the outer core portions 32 in contact with the end surface interposed members 52, are covered by the outer resin portions 42, and the surfaces of the outer core portions 32 are not exposed to the exterior.

The molded resin portion 4 is formed through injection molding, for example. In the present embodiment, the outer resin portions 42 and the inner resin portions 41 are formed integrally through the resin filling holes 524u and 524o formed in the end surface interposed members 52. The molded resin portion 4 integrates the inner core portions 31 and the outer core portions 32 and integrates the coil 2, the magnetic core 3, and the insulating interposed members 5 that constitute the combined body 10. Also, spaces between the outer core portions 32 and the inner core portions 31 are filled with resin.

Reactor Manufacturing Method

Next, an example of a method for manufacturing the reactor 1 will be described. The method for manufacturing the reactor mainly includes a combined body assembly step and a resin molding step.

Combined Body Assembly Step

In the combined body assembly step, the combined body 10 including the coil 2, the magnetic core 3, and the insulating interposed members 5 is assembled (see FIG. 3).

The set of the coil 2 and the inner core portions 31 is prepared by arranging the inner interposed members 51 between the inner core pieces 31m to form the inner core portions 31 and inserting the inner core portions 31 into the two winding portions 2c of the coil 2. Also, the gap plates 55 are attached to the end surface interposed members 52 by fitting the engagement protruding portions 551 of the gap plates 55 into the engagement recessed portions 527 (see FIG. 7) provided on the end surface interposed members 52. Then, the end surface interposed members 52 are arranged on both ends of the winding portions 2c and the outer core portions 32 are arranged so as to sandwich the inner core portions 31 from both ends. Accordingly, a ring-shaped magnetic core 3 (see FIG. 2) in which gap plates 55 are arranged between the outer core portions 32 and the inner core portions 31 is formed. In the manner described above, the combined body 10 including the coil 2, the magnetic core 3, and the insulating interposed members 5 (including the gap plates 55) is assembled.

Resin Molding Step

In the resin molding step, the outer core portions 32 are covered by resin, resin fills the spaces between the inner circumferential surfaces of the winding portions 2c and the inner core portions 31, and thus the outer resin portions 42 and the inner resin portions 41 are formed integrally (see FIGS. 4 and 5).

Resin molding is performed by arranging the combined body 10 in a mold and injecting resin into the mold from the outer core portion 32 sides of the combined body 10. An example is given in which the resin is injected from sides of the outer core portions 32 that are opposite to the sides on which the coil 2 and the inner core portions 31 are arranged. In this example, the outer core portions 32 and the end surface interposed members 52 are not fixed to the mold. Then, the outer core portions 32 are covered with resin, and the resin fills the spaces between the winding portions 2c and the inner core portions 31 via the resin filling holes 524u and 524o (see FIG. 8) of the end surface interposed members 52. Accordingly, the resin fills the resin flow paths 45 formed between the inner circumferential surfaces of the winding portions 2c and the outer circumferential surfaces of the inner core portions 31. As described above, the resin flow paths 45u and 45o that are continuous in the axial direction with the resin filling holes 524u and 524o and the coil 2 are filled with the resin through the resin filling holes 524u and 524o. Also, in the present embodiment, as shown in FIG. 8, the gap plates 55 are formed such that it is possible to ensure flow paths for resin between the outer core portions 32 and the inner core portions 31. For this reason, the resin flow paths 45d and 45i are also filled with resin due to the resin introduced through the resin filling holes 524u passing through the spaces (flow paths for resin) formed between the outer core portions 32 and the inner core portions 31. At this time, the resin also fills parts of the spaces between the outer core portions 32 and the inner core portions 31.

Thereafter, the resin is solidified, and thereby the outer resin portions 42 and the inner resin portions 41 are formed integrally. Accordingly, the molded resin portion 4 is formed by the inner resin portions 41 and the outer resin portions 42, the inner core portions 31 and the outer core portions 32 are integrated, and the coil 2, the magnetic core 3, and the insulating interposed members 5 (including the gap plates 55) are integrated.

As for the filling with the resin, the resin may fill the spaces between the winding portions 2c and the inner core portions 31 from one outer core portion 32 side to the other outer core portion 32 side, or the resin may fill the spaces between the winding portions 2c and the inner core portions 31 from both outer core portion 32 sides.

In the above-described manufacturing method, due to the fact that the gap plates 55 are interposed between the outer core portions 32 and the inner core portions 31, the intervals between the outer core portions 32 and the inner core portions 31 can be maintained even if the outer core portions 32 are pressed toward the inner core portions 31 due to pressure during resin molding. Also, in the above-described manufacturing method, in some cases, the end surface interposed members 52 are also pressed toward the coil 2 due to pressure during resin molding and the engagement between the end surface interposed members 52 and the gap plates 55 is undone. Even if the engagement between the end surface members 52 and the gap plates 55 is undone during resin molding, the end surface interposed members 52 and the gap plates 55 are molded integrally by the resin, and therefore no functional problem occurs.

Effects

The reactor 1 of Embodiment 1 exhibits the following effects.

By including the gap plates 55, it is possible to suitably maintain the intervals between the outer core portions 32 and the inner core portions 31 when performing resin molding, and therefore a predetermined inductance can be ensured.

The gap plates 55 are formed so as not to block the spaces between the resin flow paths 45u that are continuous with the resin filling holes 524u and the other resin flow paths 45d and 45i that are covered by the outer core portions 32, and thus it is possible to ensure flow paths for resin between the outer core portions 32 and the inner core portions 31. For this reason, the resin flow paths 45d and 45i are also filled with resin due to the resin introduced through the resin filling holes 524u passing through the spaces (flow paths for resin) formed between the outer core portions 32 and the inner core portions 31. Accordingly, the inner resin portions 41 can be formed due to the resin filling the resin flow paths 45.

By including the engagement structures (engagement recessed portion 527 and engagement protruding portion 551) for engaging the end surface interposed members 52 and the gap plates 55, the gap plates 55 can be attached to the end surface interposed members 52. For this reason, when the combined body 10 is assembled, it is possible to suppress a case in which the gap plates 55 come off of the end surface interposed members 52, which is excellent for workability. Furthermore, if the gap plates 55 include positioning portions 552, the outer core portions 32 can easily be positioned with respect to the end surface interposed members 52.

Application

The reactor 1 of Embodiment 1 can be suitably used in various converters, such as a vehicle-mounted converter (typically a DC-DC converter) mounted in a vehicle such as a hybrid automobile, a plug-in hybrid automobile, an electric automobile, or a fuel battery automobile, or a converter for an air conditioner, and in constituent components for electric power conversion apparatuses.

### Modified Example 1

The above-described Embodiment 1 described a mode in which the gap plates 55 are attached to the outer side surface sides of the through holes 520 of the end surface interposed members 52, as shown in FIGS. 6 to 8. There is no limitation to this, and for example, it is also possible to use a mode in which the gap plates 55 are attached to the upper surface sides of the through holes 520. In this case, the gap plates 55 need only be formed so as not to block the spaces between the resin flow paths 45o that are continuous with the resin filling holes 524o and the other resin flow paths 45d and 45i covered by the outer core portions 32. Accordingly, the resin introduced through the resin filling holes 524o can fill the resin flow paths 45d and 45i through the spaces between the outer core portions 32 and the inner core portions 31.

### Modified Example 2

The above-described Embodiment 1 described a mode in which the engagement protruding portions 551 are provided on both ends of the gap plates 55 and both ends of the gap plates 55 are supported by the end surface interposed members 52, as shown in FIG. 7. There is no limitation to this, and for example, it is also possible to provide one engagement protruding portion on each gap plate 55 shown in FIG. 7, engage with the end surface interposed member 52 at one location, and support one end of the gap plate 55 on the end surface interposed member 52. In this case, the space between the resin flow path 45o and the resin flow paths 45d and 45i is not blocked, and therefore the resin introduced through the resin filling hole 524o can be allowed to flow into the resin flow paths 45d and 45i. Accordingly, the resin introduced through the resin filling holes 524u and 524o can fill the resin flow paths 45d and 45i through the spaces between the outer core portions 32 and the inner core portions 31.

What is claimed is:

1. A reactor, comprising:
a coil including a winding portion;
a magnetic core including an inner core portion arranged inside of the winding portion and an outer core portion arranged outside of the winding portion;
an inner resin portion with which a space between an inner circumferential surface of the winding portion and the inner core portion is filled;
an outer resin portion that covers at least part of the outer core portion;
an inner interposed member that is interposed between the inner circumferential surface of the winding portion and the inner core portion and forms a plurality of resin flow paths that are to serve as flow paths for resin that forms the inner resin portion;
an end surface interposed member that is interposed between an end surface of the winding portion and the outer core portion and includes a through hole into which the inner core portion is inserted and a resin filling hole that is continuous in an axial direction of the coil with at least one flow path among the plurality of resin flow paths; and
a gap plate that is attached in the through hole of the end surface interposed member and is interposed between the outer core portion and the inner core portion,
wherein the gap plate is formed such that, when a combined body obtained by combining the coil, the magnetic core, the inner interposed member, and the end surface interposed member is viewed in the axial direction of the coil,
a space between the flow path continuous with the resin filling hole and another flow path covered by the outer core portion among the plurality of resin flow paths is not blocked.

2. The reactor according to claim 1, comprising an engagement structure for engaging the end surface interposed member and the gap plate.

3. The reactor according to claim 1, wherein the gap plate includes a positioning portion that positions the outer core portion.

4. The reactor according to claim 2, wherein the gap plate includes a positioning portion that positions the outer core portion.
